(19) United States
(12) Patent Application Publication
(10) Pub. No.: US 2026/0260483 A1
(43) Pub. Date: Sep. 3, 2026

(54) SYSTEM AND METHOD FOR IDENTIFYING SHIPS IN SATELLITE OR AERIAL IMAGERY UTILIZING AIS INFORMATION

(71) Applicant: STELLARVISION INC., Daejeon (KR)

(72) Inventors: Seungchul Lee, Seoul (KR); Jinwoo Kim, Gyeonggi-do (KR); Dongil Park, Seoul (KR); Byungjo Chu, Seoul (KR)

(21) Appl. No.: 19/364,975

(22) Filed: Oct. 21, 2025

(30) Foreign Application Priority Data
Feb. 28, 2025 (KR) 10-2025-0027112
Feb. 28, 2025 (KR) 10-2025-0027123

(51) Int. Cl. G06V 20/13; B63B 79/10; G06V 10/22; G06V 10/25; G06V 10/30

(52) U.S. Cl. CPC G06V 20/13; B63B 79/10; G06V 10/235; G06V 10/25; G06V 10/30; B63B 2213/02

(57) ABSTRACT

According to embodiments, a system and method for identifying ships in satellite or aerial imagery utilizing AIS information may include a receiver configured to receive satellite or aerial imagery and AIS (Automatic Identification System) data; a processor configured to pre-process the received AIS data and the imagery, to compute AIS data for the image capture time (ts), and to match the computed AIS data with ships detected in the imagery so as to fuse (or combine) information; and an display configured to output, as imagery, information of the ships subjected to fusion processing in the processor, wherein the processor may employ a linear interpolation method or a velocity-and-direction-of-movement-based interpolation method so that the received AIS data are corrected to values at the image capture time (ts).

### CROSS-REFERENCE TO RELATED APPLICATIONS

This application claims priority under 35 U.S.C. § 119 to Korean Patent Application No. 10-2025-0027112, filed in Korea on Feb. 28, 2025, and Korean Patent Application No. 10-2025-0027123, filed in Korea on Feb. 28, 2025, the contents of which are hereby incorporated by reference in their entireties.

### BACKGROUND

The present invention relates to a system and method for identifying ships in satellite or aerial imagery utilizing AIS (Automatic Identification System) information.

The Automatic Identification System (hereinafter referred to as “AIS”) is a ship tracking system developed to prevent ship collisions by enabling ships to recognize and identify each other's locations and navigation routes.

Under the International Maritime Organization (IMO) regulations concerning maritime safety, ships exceeding a certain gross tonnage are obligated to be equipped with AIS.

Generally, AIS transmits collected information to terrestrial or satellite receivers at intervals ranging from several seconds to several minutes, depending on the ship's speed.

The information transmitted by the AIS (hereinafter, “AIS information” or “AIS data”) includes both static information—such as ship type, width, length, height, ship name, and IMO number (International Maritime Organization)—and dynamic information—such as ship position, timestamp, course, and speed.

However, identifying whether an object observed in satellite or aerial imagery (hereinafter, “satellite imagery”) is an actual ship, or merely noise such as waves, floating debris, or offshore structures, is highly limited when relying solely on the imagery. Therefore, if AIS information could be combined or fused or adjusted or aligned with satellite imagery, it would be possible to achieve more accurate and precise ship identification.

Nevertheless, since AIS transmission can be manually turned on or off onboard a ship, not all ships transmit or receive AIS information. Accordingly, there is a need to complement ship identification by detecting ships in satellite imagery that have their AIS signals turned off.

Meanwhile, AIS information may differ from the actual position of a ship due to factors such as radio interference or signal delay. Furthermore, since AIS transmits data at irregular intervals from seconds to minutes, acquiring AIS information (e.g., position, speed, or heading) at a specific moment may be difficult.

In related art, AIS data has conventionally been matched with the most spatially or temporally proximate vessel detected in satellite imagery. However, this traditional approach does not consider parameters such as ship movement speed or direction, thereby reducing matching accuracy in images where ships are detected at high density in a small maritime space.

When satellite imagery is captured at a time between AIS transmission intervals, positional discrepancies inevitably arise when matching the ship in the imagery with AIS data. Hence, there is a need for refined estimation models considering multiple variables to estimate AIS data between transmission intervals. In other words, more precise fusion, adjustment, or alignment of AIS information with satellite imagery would enable a more advanced ship identification system.

For instance, when there is a time difference between the AIS data reception time and the satellite imaging time, synchronization between the two datasets can enable their fusion. In this regard, Korean Patent Publication No. KR 10-2020-0050736 A discloses a method for correcting viewing angle misalignment (i.e., line-of-sight error) of an imaging sensor when ship coordinates obtained from imagery and AIS ship coordinates have a time discrepancy.

However, KR 10-2020-0050736 A merely discloses a method for correcting the viewing angle of an imaging sensor based on the premise that the ship identified in the satellite imagery and the ship corresponding to the AIS data are identical. Also, KR 10-2020-0050736 A fails to account for potential errors or inaccuracies in AIS-based correction coordinates, and provides no technical consideration of environmental factors that may cause coordinate errors in imagery-based location data apart from sensor misalignment.

Therefore, in order to realize more accurate and reliable remote sensing imagery, it is necessary to reflect various environmental factors in the final results. Accordingly, there is a need for a new satellite or aerial imagery-based ship identification system utilizing AIS information that can evaluate and/or compensate for the reliability of ship coordinates derived from both satellite imagery and AIS data.

Meanwhile, Korean Patent No. 10-2723017 B1 discloses a technique in which AIS information is used in remote sensing imagery to treat ships as ground control points (GCPs). For example, KR 10-2723017 B1 matches a ship (or vessel) detected in satellite imagery with AIS data by pairing it with the spatially nearest position coordinate.

Here, the “ground control point (GCP)” refers to a point within remote sensing imagery that can be clearly identified and has known precise latitude, longitude, and altitude coordinates.

However, as described above, because AIS data is transmitted and received at irregular intervals ranging from seconds to minutes, timing discrepancies may occur between AIS transmission and the capture of remote sensing imagery. In such cases, the method disclosed in KR 10-2723017 B1 becomes inaccurate and unreliable. Therefore, to achieve higher precision and reliability in remote sensing imagery, it is necessary to propose a more advanced geometric correction method utilizing AIS information.

### SUMMARY

It is an object of the present invention to provide a ship identification system and method using AIS (Automatic Identification System) information (or Data), thereby addressing the problems of the prior art.

It is another object of the present invention to provide a ship identification system and method capable of acquiring AIS data corresponding to the image capture time of satellite or aerial images (or imageries), thereby enabling accurate identification of ships within such images.

It is a further object of the present invention to provide a ship identification system and method capable of compensating for discrepancies arising from time differences between the satellite or aerial image capture time and the AIS data reception time.

It is further object of the present invention to provide a ship identification system and method for correcting AIS data such that it reflects information corresponding to the image capture time of satellite or aerial images (or imageries), and for evaluating the reliability of such corrected data, thereby enabling the provision of more precise real-time ship information.

It is a further object of the present invention to provide a ship identification system and method capable of distinguishing or detecting or matching between ships identified in satellite images (or imageries) and ships identified based on AIS data, within the same region or coordinates.

It is a further object of the present invention to provide a ship identification system and method for precisely matching AIS data for each individual ship.

To achieve the aforementioned objects, a ship identification system for satellite or aerial imagery utilizing AIS information, according to an embodiment of the present invention, includes: a receiver configured to receive satellite or aerial imagery and AIS (Automatic Identification System) data; a processor configured to preprocess the received AIS data and imagery, calculate AIS data corresponding to the image capture time (ts), and match the calculated AIS data to ships detected in the imagery to fuse (or combine or align or adjust) an information; and a display configured to output the fused ship information as an image.

The processor may use either a linear interpolation method or velocity-and-direction-of-movement-based interpolation method, selectable by the user, to correct the received AIS data to the image capture time (ts, also called “image recording time”).

The linear interpolation method approximates each ship's motion within a user-defined region of interest (ROI) as uniform linear movement and calculates the AIS data at the image capture time (ts) accordingly.

In addition, AIS data at the image capture time (ts) can be calculated by the following Equation 1 to which the linear interpolation method is applied.

$${X}_{s} = {X}_{AIS - 1} + \frac{( {X}_{AIS + 1} - {X}_{AIS - 1} )}{{t}_{AIS + 1} - {t}_{AIS - 1}} \times ( {t}_{s} - {t}_{AIS - 1} ) \qquad Equation 1$$

$${Y}_{s} = {Y}_{AIS - 1} + \frac{( {Y}_{AIS + 1} - {Y}_{AIS - 1} )}{{t}_{AIS + 1} - {t}_{AIS - 1}} \times ( {t}_{s} - {t}_{AIS - 1} )$$

(tₛ: image capture time, Xₛ: coordinate on X-plane at image capture time, Yₛ: coordinate on Y-plane at image capture time, X_{(AIS-1)}: coordinate on X-plane in AIS data immediately prior to image capture time, Y_{(AIS-1)}: coordinate on Y-plane in AIS data immediately prior to image capture time, X_(AIS+1): coordinate on X-plane in AIS data immediately after image capture time, Y_{(AIS+1)}: coordinate on Y-plane in AIS data immediately after image capture time, t_{(AIS-1)}: reception time of AIS data immediately before image capture time, t_{(AIS+1)}: reception time of AIS data immediately after image capture time)

Also, the velocity-and-direction-of-movement-based interpolation method calculates the AIS data at the image capture time (ts) using only the AIS data received immediately before the image capture time (ts).

In addition, the AIS data at the image capture time (ts) can be calculated by the following Equation 2 to which the velocity-and-direction-of-movement-based interpolation method is applied.

$${X}_{s} = {X}_{AIS - 1} + {V}_{AIS - 1} \cdot cos {θ}_{AIS - 1} \cdot ( {t}_{s} - {t}_{AIS - 1} ) \qquad Equation 2$$

$${Y}_{s} = {Y}_{AIS - 1} + {V}_{AIS - 1} \cdot sin {θ}_{AIS - 1} \cdot ( {t}_{s} - {t}_{AIS - 1} )$$

(tₛ: image capture time, Xₛ: coordinate on X-plane at image capture time, Yₛ: coordinate on Y-plane at image capture time, X_{(AIS-1)}: coordinate on X-plane in AIS data immediately prior to image capture time, Y_{(AIS-1)}: coordinate on Y-plane in AIS data immediately prior to image capture time, t_{(AIS-1)}: reception time of AIS data immediately before image capture time)

Also, the processor may include a data processing unit for processing the received AIS data and an image processing unit for processing the received image. The image processing unit may perform rotation and scaling adjustments using the corrected AIS data at the image capture time, thereby providing an adjusted or a fusioned image to the display.

Also, to match the corrected AIS data with ship detected in the image, when the ship position of the corrected AIS data at the image capture time differs from the detected ship position, the processor can extract a positional error (d) using calculating Euclidean distance. Here, the ship position may be presented the coordinates.

Also, the processor compares the extracted error (d) against a threshold (a), which is based on evaluations of AIS data reliability and image reliability. And, if the error (d) exceeds the threshold (a), the ship position is adjusted or aligned with a value of the corrected AIS data; if the error (d) is less than or equal to the threshold (a), the ship position derived from the image is retained.

Additionally, the reliability of the AIS data can be evaluated by the following equation.

$${C}_{AIS} = exp ( - \frac{{( {X}_{s} - {X}_{v} )}^{2} + {( {Y}_{s} + {Y}_{v} )}^{2}}{{σ}_{GPS}^{2}} )$$

(C_{AIS}: a result value represents a reliability of the AIS data in range of 0 to 1, Xₛ and Yₛ: Interpolated AIS data X,Y coordinates, Xᵥ and Yᵥ: X,Y coordinates of the ship detected in an image, σ_{GPS}: GPS error margin value)

Additionally, the reliability of the image can be evaluated using the following equation:

$${C}_{VID} = exp ( - \frac{{( {X}_{s} - {X}_{v} )}^{2} + {( {Y}_{s} + {Y}_{v} )}^{2}}{{σ}_{VID}^{2}} )$$

(CVID: a result value represents a reliability of the image in the range of 0 to 1, Xs and Ys: Interpolated AIS data X,Y coordinates, Xv and Yv: X,Y coordinates of the ship detected in an image, σVID: value for total error of image reliability)

Also, the value for total error of image reliability can be defined as the sum of geometric errors due to satellite capturing (or shooting) angle and Earth curvature, hardware errors due to sensor noise or lens distortion, errors due to ship speed, and errors due to the capturing (or shooting) environment.

Additionally, the threshold value (α) can be defined by

$$\frac{{C}_{AIS}}{{C}_{AIS} + {C}_{VID}} .$$

From another perspective, a method for identifying ships in satellite or aerial imagery utilizing AIS information, according to an embodiment of the present invention, includes: receiving satellite or aerial imagery and AIS data; correcting the received AIS data to correspond to the image capture time (ts); detecting ships and designating targets within the imagery; and matching the corrected AIS data to the target ships.

Additionally, a step of correcting the received AIS data to correspond to the image capture time (ts) can calculate the corrected AIS data by considering the speed and direction of movement from the AIS data received immediately before the image capture time (ts−1).

Furthermore, in an embodiment of the present invention, if a difference is identified between the position of the target ship in the imagery and the position of a ship the corrected AIS data, the error (d) between the two locations can be extracted through Euclidean distance calculation.

In addition, the error (d) is compared with a threshold value (a) defined by an equation that reflects the reliability of AIS data and the reliability of the imagery, and based on the comparison result of the error (d) and the threshold value (a), an information value with higher reliability can be fusioned or combined or adjusted or aligned with the data of the target ship in the imagery.

### BRIEF DESCRIPTION OF THE DRAWINGS

FIG. 1 is a view illustrating an example configuration of a ship identification system according to an embodiment of the present invention.

FIG. 2 is a flowchart illustrating a ship identification method according to an embodiment of the present invention.

FIG. 3 is a flowchart illustrating a data-matching of FIG. 2.

FIG. 4 is a flowchart illustrating a first data-matching of FIG. 3.

FIG. 5 is a flowchart illustrating a second data-matching of FIG. 3.

FIG. 6 is a flowchart illustrating a correction method used, within the ship identification method according to an embodiment of the present invention, when a discrepancy occurs between the ship position of the imagery and the ship position of corrected AIS data.

FIG. 7 is a view showing a screen for searching for and setting a target ship in a region of interest (ROI) within satellite imagery, according to an embodiment of the present invention.

FIG. 8 is a view showing a screen in which a target ship in satellite imagery and AIS data matched to the target ship are fused, according to an embodiment of the present invention.

FIG. 9 is a view showing an image before geometric correction according to an embodiment of the present invention.

FIG. 10 is a view showing an image output after geometric correction according to an embodiment of the present invention

### DETAILED DESCRIPTION OF THE EMBODIMENTS

Hereinafter, some embodiments of the present invention will be described in detail with reference to exemplary drawings. When designating components in each drawing, it should be noted that identical components are assigned the same reference numerals whenever possible, even if they appear in different drawings. Furthermore, when describing embodiments of the present invention, detailed descriptions of related, well-known structures or functions will be omitted if they are deemed to hinder understanding of the embodiments of the present invention. Furthermore, terms such as “first,” “second,” “A,” “B,” (a), and (b) may be used to describe components of embodiments of the present invention. These terms are intended only to distinguish the components from other components and do not limit the nature, order, or sequence of the components.

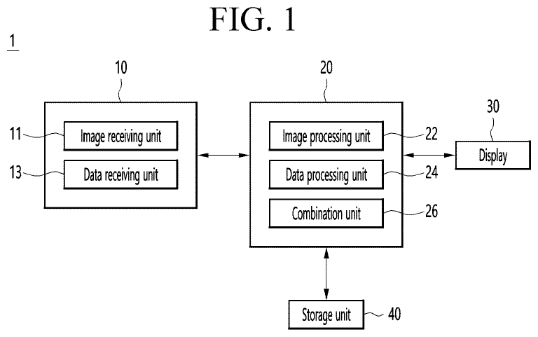

FIG. 1 is a view illustrating an example configuration of a ship identification system according to an embodiment of the present invention.

Hereinafter, for convenience of description, the term “imagery” or “image” may refer to satellite or aerial imagery. Information transmitted and received by the Automatic Identification System (AIS) may be referred to as “AIS data” or “AIS information”.

Referring to FIG. 1, a system (1) for identifying ships in satellite or aerial imagery according to embodiments of the present invention may include a receiver (10) configured to receive AIS data and imagery.

The receiver (10) may include an Image receiving unit (11) configured to receive satellite or aerial imagery and a Data receiving unit (13) configured to receive AIS data.

The Image receiving unit (11) may receive an image capture time (ts) together with the received imagery. That is, the Image receiving unit (11) may obtain the image capture time (ts) of the imagery as a time reference for acquiring AIS data.

Additionally, the Image receiving unit (11) may receive imagery of a user-selected region of interest (ROI). For example, the Image receiving unit (11) may receive a specific sea area in which multiple ships (or vessels) are sailing. The image capture time (ts) of the received imagery may be received together therewith.

The Data receiving unit (13) may receive AIS data for ships in a region corresponding to the ROI. The Data receiving unit (13) may also receive AIS data for time points before and after the image capture time (ts). For example, the Data receiving unit (13) may receive AIS data at time points ts±n (n=1, 2, 3, . . . ) relative to the image capture time (ts). Preferably, to achieve fast computation and to reflect real-time changes in ship information, AIS data at time point ts−1 may be received relative to the image capture time (ts).

In addition, the time points ts±1 may be understood as AIS data immediately prior to the image capture time (ts) and AIS data immediately after the image capture time (ts).

In some cases, depending on user requirements, AIS data at time point ts+n after the image capture time (ts) may be received and used for analysis.

Because AIS data are transmitted and received at intervals of several seconds to several minutes, the image capture time (ts) may differ from the AIS transmission or reception time. Accordingly, the Data receiving unit (13) may receive AIS data before and after the image capture time (ts).

AIS data may include static information such as ship type, class, beam, length, width, height, ship name (or call sign), and International Maritime Organization (IMO) number, etc. and dynamic information such as ship position, reception time, course (or route), velocity, heading (HDG or head angle) and speed, etc.

The system (1) for identifying ships in satellite or aerial imagery may further include a processor (20) configured to process the received AIS data and the imagery.

The processor (20) may perform a preprocessing operation to remove noise or outliers in AIS data for time points before or after the image capture time (ts) of the satellite or aerial imagery.

For example, the received AIS data may contain duplicate unique identification ship information (ex: IMO number etc.) or positional errors caused by GPS equipment anomalies, and the processor (20) may validate and sanitize such AIS data through preprocessing.

In another example, where a user error or deliberate manipulation causes duplication of unique identification ship information so that the same unique identification ship information is transmitted from two or more ships, the processor (20) may, based on information such as position, course, and velocity, separate the ships associated with the duplicated unique identification ship information into respective individual ship records and extract data for ships corresponding to the region of interest (ROI), by performing preprocessing.

Meanwhile, AIS data may exhibit positioning errors due to temporary GPS equipment faults or failures.

According to embodiments described below, because the processor (20) evaluates the reliability of AIS data and reflects information with higher reliability in the final output, it can readily distinguish fundamental AIS data errors—caused by the GPS equipment or the like—from mere time-offset discrepancies relative to the image capture time, and remove or correct such errors in the output.

Furthermore, the processor (20) may discover ships within the ROI in the imagery for which no AIS data are received. In this case, the processor (20) may feedback to preprocessing to designate such ships as unregistered ships or black ships and process to output ship information obtainable from imagery alone.

Additionally, the imagery may include noise due to floating objects, structures, waves, or other marine environmental factors, and the processor (20) may perform preprocessing to remove such noise.

The processor (20) may also perform a correction procedure for time differences between the image capture time (ts) and AIS timestamps arising from AIS transmission intervals. The processor (20) may also perform a correction procedure for time differences between the image capture time (ts) and AIS timestamps arising from AIS transmission intervals.

That is, the processor (20) may correct AIS data. specifically, the processor (20) may compute AIS data at the image capture time (ts) based on AIS data received before and after the image capture time (ts).

For example, the processor (20) may apply linear interpolation or a velocity-and-direction-of-movement-based interpolation method to compute AIS data at the image capture time (ts), details of which are described later.

Additionally, the processor (20) may search for a user-specified target ship in the received ROI imagery and identify the position of the target. The processor (20) may then match the target ship with the corrected AIS data to fuse (or combine or align or adjust) the ship in the imagery at the image capture time (ts) with the AIS data.

Moreover, when a difference (i.e., an error) arises between the target ship position in the imagery and the ship position in the corrected AIS data, the processor (20) may compute the difference (error) value by Euclidean distance and compute and compare the respective reliabilities of the imagery and the AIS data. Here, the ship position described above can be expressed in coordinates.

Also, the processor (20) may determine whether the difference (error) exceeds a threshold and, based on the result, may apply the data with higher reliability (e.g., position values). Accordingly, the final output imagery may provide more precise and accurate ship-specific fusion data.

The processor (20) may include a data processing unit (22) that preprocesses and corrects the received AIS data (22), an image processing unit (24) that preprocesses the received imagery and searches for and sets a target ship within a user-selected region of interest (ROI), and a combination unit (26) that matches and fuses (or combines) the corrected AIS data by the data processing unit (22) with each target within the ROI.

The data processing unit (22) may filter out reception errors such as positional errors caused by signal interference during the preprocessing.

If the intervals between received AIS data are irregular, the data processing unit (22) may employ linear interpolation or velocity-and-direction-of-movement-based interpolation to compute AIS data (especially dynamic information) at the image capture time (ts).

Linear interpolation assumes the ship moves at a constant speed in a straight line, enabling rapid computation, which is advantageous for users handling large-scale and extensive imagery.

When a ship within a designated window in the user's ROI is evaluated to move at a constant speed and in a straight line, the processor (20) may compute AIS data at the image capture time (ts) using linear interpolation according to the following equation 1.

$${X}_{s} = {X}_{AIS - 1} + \frac{( {X}_{AIS + 1} - {X}_{AIS - 1} )}{{t}_{AIS + 1} - {t}_{AIS - 1}} \times ( {t}_{s} - {t}_{AIS - 1} ) \qquad [ Equation 1 ]$$

$${Y}_{s} = {Y}_{AIS - 1} + \frac{( {Y}_{AIS + 1} - {Y}_{AIS - 1} )}{{t}_{AIS + 1} - {t}_{AIS - 1}} \times ( {t}_{s} - {t}_{AIS - 1} )$$

Here, tₛ denotes the image capture time, Xₛ and Yₛ denote the position coordinates (X, Y) at the image capture time, X_{AIS-1} and Y_{AIS-1} denote the ship's (X, Y) position in the AIS data immediately prior to the image capture time, X_{AIS+1} and Y_{AIS+1} denote the ship's (X, Y) position in the AIS data immediately after the image capture time, t_{AIS-1} denotes the reception time of the AIS data immediately before the image capture time, t_{AIS+1} denotes the reception time of the AIS data immediately after the image capture time.

According to Equation 1, AIS data at the image capture time (ts), particularly dynamic information, can be computed using the AIS data immediately before and after the image capture time (ts).

Interpolation considering velocity and direction of movement is based on the AIS data at time t−1 and considers the ship's speed and movement direction. This method is preferable for users requiring more precise analysis and matching.

The processor (20) may compute AIS data at the image capture time (ts) using velocity-and-direction-based interpolation according to Equation 2 below to precisely track or analyze a target ship within the user-selected region of interest (ROI).

$${X}_{s} = {X}_{AIS - 1} + {V}_{AIS - 1} \cdot cos {θ}_{AIS - 1} \cdot ( {t}_{s} - {t}_{AIS - 1} ) \qquad [ Equation 2 ]$$

$${Y}_{s} = {Y}_{AIS - 1} + {V}_{AIS - 1} \cdot sin {θ}_{AIS - 1} \cdot ( {t}_{s} - {t}_{AIS - 1} )$$

Here, tₛ denotes the image capture time, Xₛ and Yₛ denote the position coordinates (X, Y) at the image capture time, X_{AIS-1} and Y_{AIS-1} denote the ship's (X, Y) position in the AIS data immediately prior to the image capture time, V_{AIS-1} denote the ship's velocity (m/s) in the AIS data immediately prior to the image capture time, θ_{AIS-1} denote the movement direction (azimuth angle, ‘degrees’) in the AIS data immediately prior to the image capture time.

According to Equation 2, by computing the cos(θ) and sin(θ), the ship's position at the image capture time (ts) can be corrected considering its movement direction.

Therefore, using Equation 2, AIS data at the image capture time (ts), particularly dynamic information, can be computed based on previous AIS data.

The Image processing unit (24) may perform rotation and scaling of the imagery based on AIS data at the image capture time (ts) computed or corrected by the Data processing unit (22). Accordingly, the target ship in the imagery may be rendered as imagery in which AIS data are fused (or combined or aligned or adjusted). Hereinafter, the AIS data at the image capture time are referred to as “corrected AIS data”.

Meanwhile, the processor (20) may perform geometric correction by using a target ship, for which corrected AIS data have been fused, as a “Sea Control Point”. For example, the Combination unit (26) may define multiple target ships in the imagery as sea control points.

A target ship for which the corrected AIS data have been completely fused (or combined) may also have real-world coordinates such as true latitude, true longitude, and true altitude. Accordingly, the Combination unit (26) may define a transformation model for geometric correction by comparing the pixel coordinates (x, y) of the imagery with the ship's actual coordinates (X, Y) at the sea control point.

For example, the processor (20) may define the mapping relationship between pixel coordinates (x, y) and actual coordinates (X, Y) by setting a polynomial based on the AIS data of the sea control point and the imagery information.

Additionally, the Combination unit (26) may perform a first-order transformation (linear transformation) and a second-order transformation (nonlinear transformation).

Further, in the first-order transformation, the Combination unit (26) may perform translation, rotation, and scaling to align the target's image coordinates with the AIS coordinates (i.e., actual coordinates).

Therefore, even in sea environments (particularly the open ocean) where objects satisfying the conventional “GCP, Ground Control Point” definition are scarce, the accuracy and precision of geometric correction can be improved.

Additionally, when multiple ships within the ROI are detected with high density, the Combination unit (26) may determine whether a ship in the imagery matches a record in the AIS data based on the unique identification ship information.

The Combination unit (26) may also identify cases where a difference arises between the target's ship position in the imagery and the ship position in the corrected AIS data.

Moreover, the processor (20) may compute the error (d) between the two positions by Euclidean distance and perform a reliability evaluation process so that higher-reliability data are fused (or combined) to the target.

The system (1) for identifying ships in satellite or aerial imagery may further include a display (30) and a Storage unit (40).

The display (30) may output, as imagery, the results processed by the processor (20). For example, at the image capture time (ts), the display (30) may output imagery in which corrected AIS data are fused (or combined or aligned or adjusted) for each target ship.

The Storage unit (40) may store the results of each operation performed by the processor (20), and the information stored in the Storage unit (40) may be loaded at the request of the processor (20).

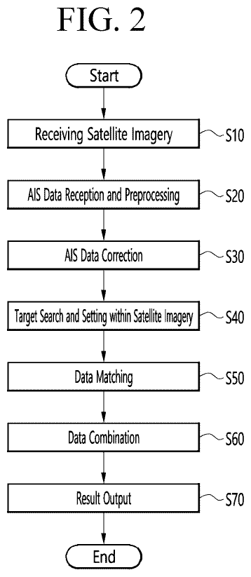

FIG. 2 is a flowchart illustrating a ship identification method according to an embodiment of the present invention.

Referring to FIG. 2, the ship identification method utilizing satellite or aerial imagery according to embodiments of the present invention may include a step (S10) of receiving imagery. Here, “imagery” can be understood to mean satellite or aerial imagery as described above.

The imagery may be received at the receiver (10) together with the image capture time (ts). The receiver (10) may receive imagery for a user's Region Of Interest (Hereinafter, “ROI”). For example, the image receiving unit (11) may receive an imagery by optical satellite and/or synthetic aperture radar (SAR) with the image capture time (ts), for the ROI.

In addition, the ship identification method according to embodiments of the present invention may include a step (S20) of receiving AIS data and preprocessing AIS data.

Here, the step of receiving AIS data and preprocessing AIS data (S20) may be performed simultaneously with the above-mentioned step of receiving imagery (S10). For example, while an imagery for the ROI is secured, AIS data for ships existing in the ROI can be received through the receiver (10). Here, the received AIS data may include information before or after the image capture time (ts).

Also, the received AIS data may undergo preprocessing to remove noise or abnormal values. For example, positional errors caused by signal interference in the received AIS data may be filtered out during preprocessing.

Furthermore, noise in the imagery may also be processed together in the preprocessing step (S20). The preprocessing may be performed by the processor (20).

In some cases, ships may appear in the imagery of the ROI without a corresponding AIS data record. In such cases, ships with no matching AIS data may be fed back to the preprocessing step (S20) for further handling.

For example, if a ship appears in the imagery but has no AIS data, the processor (20) may classify that ship as an unregistered ship or black ship and store it in a separate file. The processor (20) may also feed that ship back to the preprocessing step so that it is excluded or filtered from the list of candidates for the matching algorithm.

In another example, during a step of a data matching (S60), ships without AIS data may be handled only based on information available from the imagery itself.

Once preprocessing of the received AIS data is complete, a step (S30) of correcting the AIS data may be performed.

The step of correcting the AIS data (S30) can adjust or compensate for differences between imagery information and AIS data information that arise due to variations in transmission and reception intervals for each ship's AIS data. That is, the S30 step is a step of correcting received AIS data in order to acquire per-ship AIS data at the image capture time (ts).

For example, the S30 step may compute AIS data (particularly dynamic information) at the image capture time (ts) using linear interpolation or velocity-and-direction-of-movement-based interpolation based on AIS data received before or after the image capture time (ts).

The ROI within the imagery may be represented as a window.

Additionally, in step S30, it may be determined whether a ship detected in the window can be evaluated or approximated as moving at a constant velocity in a straight line. For example, the processor (20), based on the area covered by the ROI (or “window size”) and on the trajectory and tracking time of the ship, may determine whether the ship can be approximated as moving at a constant velocity in a straight line. If the ship can be so approximated, the high-volume processing speed for calculating AIS data at the image capture time (ts) can be improved.

Where a ship is evaluated as moving at a constant velocity in a straight line, the processor (20) may calculate AIS data at the image capture time (ts) using Equation 1 for linear interpolation.

If linear interpolation is not suitable in step S30, or if precision is desired based on ship speed and direction, the processor (20) may compute AIS data at the image capture time (ts) using Equation 2 for velocity-and-direction-of-movement-based interpolation.

In such cases, AIS data at the image capture time (ts) may be computed based on ship speed and direction derived from the AIS data immediately prior to the image capture time (t−1).

AIS data calculated using either Equation 1 or Equation 2 as described above may be referred to as “corrected AIS data.”

Once the step of correcting the AIS data (S30) is complete, a step (S40) of searching for and setting a target ship within the ROI may be performed.

Of course, when an imagery is received by the receiver (10), the ship in the received imagery can be detected and classified by the processor (20) simultaneously with the above-described AIS data receiving, preprocessing, and correction processes. That is, steps S10 to S40 can be performed simultaneously.

For example, the image processing unit (22) may search for and extract ships within the ROI from the received imagery. Here, the search and extraction of ship images can be performed by using known deep learning (including machine learning) methods.

The S40 step can also be understood as a stage of setting the target ship for AIS data matching or combining among ships present in the ROI displayed as a window Therefore, in the S40 step, a target ship can be set for matching corrected AIS data. or example, the image processing unit (22) may select a target among the ships detected in the ROI imagery for matching with the corrected AIS data.

Additionally, in the S40 step, the user may set ships that they desire to track, or ships that meet predetermined criteria, as targets. For example, a ship that can be defined as a Sea Control Point (SCP) may be set as a target in the S40 step.

In addition, the processor (20) may designate a Bounding Box (BB) for each ship extracted within the ROI. The bounding box (BB) may be defined as a rectangle having the same length, width, and heading as the extracted ship.

Specifically, the length of the bounding box (BB) may be equal to the length of the extracted ship, and the width of the bounding box may be equal to the width of the extracted ship. Moreover, the bounding box (BB) may be formed so that its principal axis direction matches the heading direction (i.e., bow angle) of the extracted ship, with a center of the bounding box set at a center of the extracted ship.

A ship extracted in the ROI for matching with the corrected AIS data may therefore be displayed along with its bounding box (BB), in the S40 and S50 steps.

According to embodiments of the present invention, the ship identification method may further include a step (S50) of matching the corrected AIS data with the target ship displayed by the bounding box (BB).

In accordance with the step S30 described above, corrected AIS data for each ship at the image capture time (ts) can be obtained. Accordingly, ship coordinates for each ship at the image capture time (ts) can be acquired based on the corrected AIS data.

In the S50 step, the target ship (BB) present at the coordinates of the corrected AIS data in the ROI may be identified and matched. For example, if a target ship set in the ROI is located at the ship position (coordinate) given by the corrected AIS data, then the processor (20) may match the target ship and the corrected AIS data.

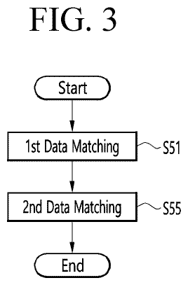

However, even in cases where AIS data are corrected to the image capture time, errors can occur due to communication environment, weather conditions, natural environment, and human error. Therefore, cases may arise where the coordinates of the target ship (BB) and the coordinates of the corrected AIS data within the ROI do not match exactly. In such circumstances, the processor (20) may determine the target ship for which the corrected AIS data should be matched or fused. Detailed embodiments of a method for matching the target ship and corrected AIS data will be described later with reference to FIGS. 3 to 5.

Once the target ship and corrected AIS data have been matched in the S50 step, a step (S60) of combining or adjusting or fusing or merging all data (e.g., both satellite data and AIS data) for the target ship at the image capture time (ts) may be performed.

The target ship, for which AIS data have been fused, may be accurately provided with reliable coordinates within the imagery and may be used in various processes, such as geometric correction. Furthermore, various static and dynamic information may be included for the target ship with fused AIS data. Based on such high-reliability information, users may utilize the method for ship tracking and identification at sea, as well as for various satellite imagery analysis and processing tasks.

For example, in the S60 step, the ship with fused or combined AIS data may be set as a Sea Control Point (SCP). Furthermore, a plurality of such Sea Control Points may be defined. Therefore, geometric correction of the satellite imagery may be performed using information (e.g., AIS data) held by these Sea Control Points.

In addition, the ship identification method according to an embodiment of the present invention may further include a step (S70) of outputting to the user the result of the fusion of corrected AIS data for each target ship in the imagery of the ROI.

Accordingly, because each ship in the imagery is fused with AIS data, not only static information but also dynamic information can be output, thereby providing far more precise and extensive information than in cases where ships are identified at sea using imagery alone.

Furthermore, in the aforementioned ship identification method, the transmission/reception time of the AIS data and the satellite imagery capture time are matched, so that information from multiple sources for the same ship can be accurately fused, combined, adjusted, or aligned.

Hereinafter, a detailed embodiment of the present invention for matching the target ship and the corrected AIS data in the above-described S50 step will be explained.

FIG. 3 is a flowchart illustrating a data-matching of FIG. 2.

Referring to FIG. 3, the S50 step may include a first data matching step (S51) and a second data matching step (S55). The second data matching step (S55) may be performed after completion of the first data matching step (S51). That is, the second data matching step (S55) may further reflect the results from the first data matching step (S51).

For example, the first data matching step (S51) may match the corrected AIS data with the target ships in the imagery. Then, the second data matching step (S55) may match the remaining corrected AIS data with the remaining target ships following the first data matching.

This two-stage matching process improves the accuracy and completeness of associating corrected AIS data with detected ships in the satellite or aerial imagery.

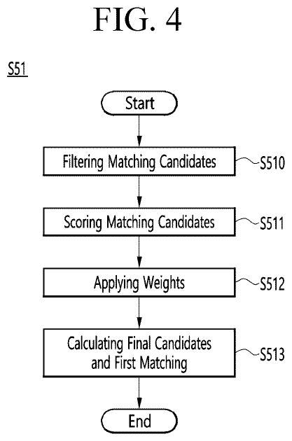

FIG. 4 is a flowchart illustrating a first data-matching of FIG. 3.

Referring to FIG. 4, the first data matching step (S51) is described in detail.

The first data matching step (S51) may include a matching candidate filtering step (S510), which compares distance, size (including length and width), and heading angle (or bow angle) between the corrected AIS data and bounding boxes (BB).

Here, the heading angle refers to the ship's bow direction, understood as an angle measured clockwise from the meridian line at 0 to 360 degrees.

As described above, ship information provided from the corrected AIS data can include position (coordinates), length, width, and heading angle.

Accordingly, the matching candidate filtering (S510) can be understood as a step of setting a candidate group to determine which bounding box (BB) among the multiple bounding boxes displayed in the region of interest (ROI) corresponds to a specific ship provided from the corrected AIS data.

More specifically, the matching candidate filtering (S510) may compare the distance between a position (provided as coordinates) from the corrected AIS data and a center point of the bounding box (BB).

Here a bounding box (BB) where the distance between a position of the corrected AIS data and a center of the bounding box exceeds 1200 m (Meter) may be excluded from matching candidates. Preferably, a bounding box where that distance exceeds 800 meters can be excluded.

A judgment criterion of the distance about the center of the bounding box and the corrected AIS data can be derived from statistical experiments using verified data about ships identified in imagery and their AIS data. According to the experiments, the average distance between the center of the bounding box and matched AIS data in the verified data is interpreted as approximately 80 meters. Therefore, the judgment criterion of the distance can be set between 800 and 1200 meters by applying approximately 2.56 (standard deviations) assuming a normal distribution.

Also, the judgment criterion of the distance is the most reliable filtering condition for matching between AIS data and bounding boxes. That is, AIS data and bounding boxes (BB) can be compared in the order of distance, size (including length and width), and heading angle to filter candidates for matching. In other words, distance, size, and heading angle should be compared sequentially for candidate filtering.

If size or heading angle is compared before distance, the experiment showed a higher probability of erroneous matching results.

Also, the matching candidate filtering (S510) can compare the sizes of AIS data and bounding boxes (BB) after the distance comparison between them is completed. That is, after distance filtering is completed, size comparison between the corrected AIS data and bounding boxes can be performed.

Here, the size comparison involves comparing length and width differences of ships.

Specifically, 50% of a ship length of the AIS data and 50% of a ship width of the AIS data are set as the judgment criterion for length and width comparison.

If a length difference between the AIS data and the bounding box exceeds 50% of the ship length of the AIS data, the corresponding bounding box may be excluded from matching candidates.

Also, if a width difference between the AIS data and the bounding box exceeds 50% of the ship width of the AIS data, the corresponding bounding box may be excluded from matching candidates.

Thus, any bounding box failing the length or width threshold is excluded from candidates.

Additionally, the matching candidate filtering (S51) can compare the heading angle after the distance and size comparison between the AIS data and the bounding box (BB) is completed. That is, after comparison of distance, length and width, heading angle is compared.

For example, if a difference value of the heading angle between the AIS data and the bounding box (BB) exceeds 20°, the corresponding bounding box (BB) may be excluded from the matching candidates.

Bounding boxes filtered by the step of the matching candidate filtering (S511) may be set as matching candidates.

Moreover, the first data matching (S51) may further include a step (S511) of a scoring matching candidates after S510 filtering.

In the step of the scoring matching candidates (S511), each bounding box in the candidate group is scored based on distance, size, and heading angle.

In details, the distance range (0-1200 m) between corrected AIS data and a bounding box center can be scored from 0 to 12 points. For example, if the distance between the position of the corrected AIS data and the center point of the bounding box (BB) is 1000 m, the distance score of the corresponding bounding box (i.e., candidate) in step S511 is 10 points.

Additionally, in the step of the scoring matching candidates (S511), the range of the length difference (0-50%) between the length of the AIS data and the length of the bounding box (BB) can be scored from 0 to 5 points. For example, if the difference value between the length of the AIS data and the length of the bounding box (BB) is 25% of the length of the AIS data, the length score of the bounding box (i.e., candidate) in the S511 step is 2.5 points.

Furthermore, in the step of the scoring matching candidates (S511), the range of the width difference (0-50%) between the width of the AIS data and the width of the bounding box (BB) can be scored from 0 to 5 points. For example, if the difference value between the width of the AIS data and the width of the bounding box (BB) is 25% of the width of the AIS data, the width score of the corresponding bounding box (i.e., candidate) in the S511 step is 2.5 points.

Furthermore, in the step of the scoring matching candidates (S511), the difference between the heading angle of the AIS data and the heading angle of the bounding box (BB) can be converted to a normalized value in the range of 0 to 2 and scored. For example, if the difference value between the heading angle of the AIS data and the heading angle of the bounding box (BB) is 15°, the angle score of the corresponding bounding box (i.e., candidate) in the S511 step is 1.5 points.

The first data matching (S51) may further include a step (S512) of applying weights for each judgment criterion to matching candidates for which scoring (S511) has been completed.

That is, after scoring, performing the step (S512) of an applying weight where weighting factors are applied in proportion to order of the judgment criterions.

The weights can be set in proportion to the order of the judgment criterions. For example, in the applying weight (S512), the distance score can be weighted at 70%, the length score at 15%, the width score at 10%, and the angle score at 5%. That is, weights are proportional to criteria importance; distributions may be: distance 70%, length 15%, width 10%, angle 5%.

The weight (%) for each of the judgment criterions can be set based on statistical experiments using verified data about the specific ship in the aforementioned imagery and its AIS data. According to the statistical experiments, the reliability and accuracy of matching are relatively high when the judgment criterions are ordered in the following order: distance, length, width, and heading angle. Therefore, the ratio of the weights can be set to have higher values in the order of filtering: distance, length, width, and heading angle.

For example, if one of the matching candidates has a bounding box (BB) with a distance of 500 m, a length difference of 5%, a width difference of 5%, and a heading angle difference of 5° based on corrected AIS data, the weighted score for the bounding box (BB) would be 3.5 points for distance, 0.075 points for length, 0.075 points for width, and 0.025 points for angle.

Also, the first data matching (S51) may further include a step (S513) of determining a final candidate by adding up the scores for each judgment criterion for which weighting has been completed, and performing a first matching with the AIS data.

That is, the S513 step of a final candidate selection summing weighted scores to select top candidates.

The final candidate determination is based on the sum of the weighted scores for each bounding box within the matching candidate set.

For example, in step S513, the weighted scores according to the judgment criterion for each bounding box within the matching candidate set are summed. A lower summed score can result in a higher ranking among the matching candidates.

The final candidate can be set to the top five bounding boxes. (Relative requirements for the final candidate) Furthermore, the final candidate can only be accepted if the sum of the weighted scores is 5 or less. (Absolute requirements for the final candidate)

Additionally, the final candidate for each AIS data can be stored in the storage unit (40).

The AIS data can be matched with a candidate with the lowest score (i.e., highest rank) among the final candidates that satisfy both relative and absolute requirements (first matching).

The corrected AIS data through the first data matching flow described above can have individually determined and stored final candidates.

Also, bounding boxes that have already completed the primary matching are excluded from the next matching candidate filtering or decision stage, and thus cannot be included as final candidates for other AIS data.

According to the first data matching flow (S51) reduces computation bottleneck by filtering and scoring candidates based on proximity to AIS data, thereby improving system responsiveness and speed.

However, in the step of the first data matching, strict thresholds on distance, size, width, and heading angle may cause exclusion of some valid matches. Therefore, the ship identification method according to an embodiment of the present invention can provide a supplementary second data matching (S55) for finding ships missed in the first data matching (S51).

Meanwhile, the step of the second data matching (S55) may be performed based on different criteria than the step of the first data matching (S51). For example, the second data matching (S55) may perform a flow for matching AIS data based on the bounding box (BB), which is the reverse of the first data matching (S51).

Therefore, a more rigorous and additional filtering process (e.g., excluding cluster of ships and filtering for differences in bow angle) may be required. The additional filtering process can prevent matching errors, thereby improving the quality of matching between AIS data and bounding boxes. In other words, the reliability of the results of the present invention can be improved. Furthermore, the matching accuracy between AIS data and the bounding box (i.e., target ship) can be maximized through the step of the second data matching (S55), which will be described in detail later. Additionally, the step (S55) of the second data matching can complement the first data matching (S51) by identifying ships missed during the step of the first data matching. Also, the second data matching (S55) can save the post-processing cost of the ship identification system compared to conventional technologies.

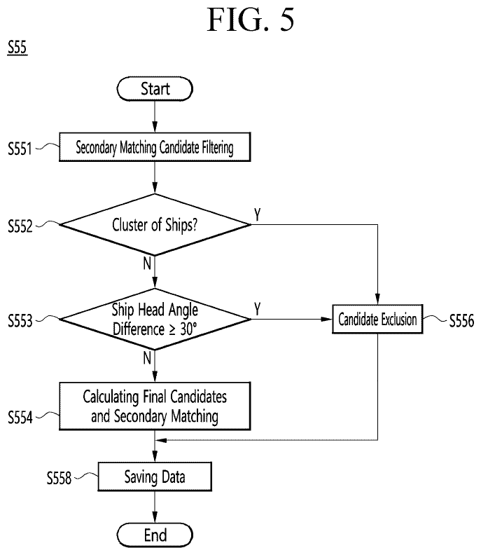

FIG. 5 is a flowchart illustrating a second data-matching of FIG. 3.

Referring to FIG. 5, the second data matching (S55) will be described in detail.

The AIS data and the bounding box matched during the first data matching (S51) may be stored as pairs in the storage unit (40). These pairs may be fused or combined as a single data entity in step S60.

The second data matching (S55) may include a step (S551) of a second matching candidate filtering.

In the step (S551) of a second matching candidate filtering, pairs (or matched data) from the first data matching (S51) are excluded, and the remaining bounding box (“secondary bounding box”) and the remaining corrected AIS data (“secondary AIS data”) are loaded. Here, the secondary AIS data is understood to be corrected AIS data at the image capture time (ts) as previously described.

In the step (S551) of the second matching candidate filtering, it is determined whether any secondary AIS data exist within 150 meters of a center point of a secondary bounding box in the ROI.

Secondary AIS data located within 150 meters from the center point of the secondary bounding box are included in the second matching candidate group, whereas those beyond 150 meters are excluded.

Further, the second data matching (S55) may further include a step (S552) to determine whether the secondary bounding box and/or secondary AIS data correspond to cluster of ships.

Cluster of ships refer to multiple ships densely arranged in a specific small area, such as ships docked closely side by side in a harbor. Such cluster of ships may cause overlapping or interference of bounding boxes, distortion or ambiguity in bounding box shapes. In addition, the cluster of ships may cause multiple pieces of information overlapping or interfering among the multiple secondary AIS data.

Based on these characteristics of the cluster of ships, the processor (20) may identify whether a secondary bounding box and/or a secondary AIS data corresponds to the cluster of ships.

Meanwhile, the cluster of ships can cause overlap or duplication between multiple bounding boxes, which can distort information such as the size of the target ship for matching. For example, the cluster of ships can cause errors in calculations related to the center point of the bounding box.

Furthermore, synthetic aperture radar (SAR) may have limited resolution to distinguish the cluster of ships.

Furthermore, the cluster of ships can make it difficult to distinguish or extract between smaller ship and increase noise due to interference.

Accordingly, the second data matching (S55) may exclude secondary bounding box and/or secondary AIS data from matching candidates if they are determined to be the cluster of ships. (S556)

That is, even if there are a number of secondary AIS data having a distance of 150 meters or less from the center point of the secondary bounding box (BB), if the secondary AIS data and/or the secondary bounding box correspond to the cluster of ships, they are excluded from the second matching candidate group and then can be stored as a separate group in the storage unit (40).

Furthermore, the second data matching (S55) may further include a step (S553) for determining whether the heading angle difference between secondary bounding box and secondary AIS data is greater than a threshold.

In detail, if the secondary bounding box (BB) and/or secondary AIS data that have completed the step (S551) of the secondary matching candidate filtering are not the cluster of ships, a difference in the heading angle between the secondary bounding box (BB) and the secondary AIS data can be calculated and compared. (S553)

Here, if a difference value in the heading angle between the secondary AIS data about the secondary bounding box is greater than 30°, the corresponding secondary bounding box and/or secondary AIS data can be excluded from the matching candidates. (S556) Here, the threshold is 30°

Due to ship maneuvering characteristics, a heading angle difference of 300 or more between bounding box and AIS data generally indicates distinct ships. Specifically, a ship's turning radius is limited, ranging from a few meters to several hundred meters, depending on the ship type (small to large). In other words, ships are inherently incapable of making sharp turns. Furthermore, considering the inertia of a large ship, the time required for the ship to change direction, and the constraints on changing direction according to the ship's speed, secondary AIS data with a difference value of 30° or more in the heading angle for the secondary bounding box can be regarded as a different ship.

The second data matching (S55) may further include a step (S554) of performing second matching by determining a final candidate when the difference in the heading angle between the secondary bounding box and the secondary AIS data is less than a threshold angle. Here, the threshold angle is 30°

That is, if the heading angle difference is less than 30°, the secondary bounding box and the secondary AIS data are finalized as candidates, and matching is performed.

In this case, the secondary bounding box is matched with the secondary AIS data closest to its center point of the secondary bounding box among the final candidates. (Second matching)

Once matched, pairs of secondary bounding box and secondary AIS data are stored in the storage unit (40) (S558).

The method of the second data matching (S55) improves matching accuracy and reliability while preventing errors caused by clustered ships and heading angle inconsistencies.

Therefore, through first and second data matching steps (S51 and S55), AIS data can be precisely matched to target ships in the ROI.

Meanwhile, the ship information (for example, position) provided by the corrected AIS data based on the image capture time (ts) may not correspond with the information extractable from the imagery due to errors caused by various environmental factors.

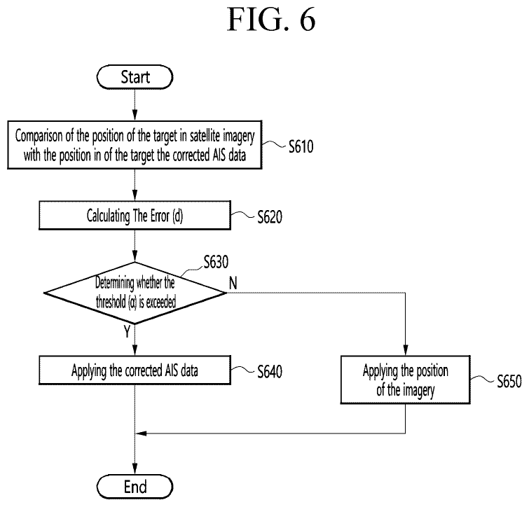

Accordingly, in step S60, where the corrected AIS data are fused (or combined or adjusted or aligned) with the ship appearing in the imagery, it is necessary to determine whether the corrected AIS data can be regarded as reliable by taking into account the influence of such errors. This process will be described in detail below with reference to FIG. 6.

FIG. 6 is a flowchart illustrating a correction method used, within the ship identification method according to an embodiment of the present invention, when a discrepancy occurs between the ship position of the imagery and the ship position of corrected AIS data.

The processor (20) may identify cases in which the position of the target ship in the imagery differs from the position of the corrected AIS data In such cases, the processor (20) may extract and store a difference between the two positions (hereinafter referred to as “error (d)”) by calculating a Euclidean distance.

According to embodiments of the present invention, the processor (20) may determine whether the error (d) is greater or smaller than a threshold reflecting a reliability evaluation formula; thus, data with higher reliability values may be fused into the target ship.

Referring to FIG. 6, in step (S60), which combines or fuses the corrected AIS data with the target ship, the position values in the imagery (i.e., coordinates on each plane) may be compared with position values determined by the corrected AIS data (i.e., coordinates on each plane) (S610). The comparison in step S610 can be understood as comparing the positions of the corrected AIS data and those of the target ship in the imagery

Through this comparison, the processor (20) may compute the error (d) between the position (coordinate) data provided by two sources—the imagery and the AIS data (S620).

The error (d) follows Equation 3 below, which represents the Euclidean distance between the corrected AIS data and the target ship's position in the imagery.

$$Error ( d ) = \sqrt{{( {X}_{image} - {X}_{t\_AIS Data} )}^{2} + {( {Y}_{image} - {Y}_{t\_AIS Data} )}^{2}} \qquad [ Equation 3 ]$$

Here, X_{image} and Y_{image} represent the planar coordinates of the ship within the imagery, X_{t_AIS Data} and Y_{t_AIA Data} represent the planar coordinates of the ship in the corrected AIS data at the image capture time (ts).

After calculating the error (d), it may be determined whether the error (d) exceeds a threshold (a) (S630).

The following describes in detail the threshold (a) according to embodiments of the present invention.

Sources of error in AIS data may include GPS-related errors such as satellite signal path (multi-path) errors, ionospheric and tropospheric refraction errors, satellite orbit (ephemeris) errors, and internal noise and computational errors of the GPS receiver. In this regard, the reliability of the AIS data may be evaluated according to Equation 4 below.

$${C}_{AIS} = exp ( - \frac{{( {X}_{s} - {X}_{v} )}^{2} + {( {Y}_{s} + {Y}_{v} )}^{2}}{{σ}_{GPS}^{2}} ) \qquad [ Equation 4 ]$$

Here, CAIS represents a resulting value indicating the reliability of AIS data in the range of 0 to 1. Xs and Ys denote the coordinates of the AIS data obtained after interpolation, Xv and Yv denote the coordinates of the ship detected within the imagery. And, σGPS represents the GPS error range value (for example, approximately 3 m for a standard GPS receiver and 1 m when using a high-precision RTK GPS system).

In addition, the causes of error in satellite or aerial imagery may include geometric distortion of the imagery, satellite viewing angle, geometric correction errors of sensors, hardware errors (such as sensor noise or optical errors), lens distortion of the camera, CMOS sensor noise, and environmental influences such as atmospheric conditions, sea state, clouds, haze, and wave effects.

In connection with this, to evaluate the reliability of the imagery, Equations 5 through 7 may be defined as follows.

$${σ}_{VID} = {σ}_{geo} + {σ}_{hw} + {σ}_{motion} + {σ}_{camera} \qquad [ Equation 5 ]$$

Here, σVID denotes the total error value of imagery reliability, σgeo represents geometric errors such as those caused by satellite viewing angle and Earth curvature, σhw represents hardware error values, including sensor and lens distortion, σmotion represents error values caused by ship speed, σcamera denotes error values resulting from capturing (or shooting) environment conditions.

Meanwhile, amotion follows Equation 6 below.

$${σ}_{motion} = {V}_{s} \cdot Δ t \qquad [ Equation 6 ]$$

Here, Vs denotes the speed of the ship (m/s), and Δt represents the time offset (sec) at the image capture time.

In addition, a camera represents an error value based on the capturing angle (that is, oblique angle) and the exposure time, which can be expressed by Equation 7 below.

$${σ}_{camera} = \frac{H}{tan ( ϕ )} + {V}_{s} \cdot {t}_{exp} \qquad [ Equation 7 ]$$

Here, H denotes the satellite imaging altitude (m), φ denotes the satellite imaging angle (degree), Vs denotes the ship's speed (m/s), texp denotes the camera exposure time (sec).

According to Equations 5 through 7, the reliability of imagery (CVID) may be evaluated by Equation 8 below.

$${C}_{VID} = exp ( - \frac{{( {X}_{s} - {X}_{v} )}^{2} + {( {Y}_{s} + {Y}_{v} )}^{2}}{{σ}_{VID}^{2}} ) \qquad [ Equation 8 ]$$

Here, CVID is a result value indicating imagery reliability within a range of 0 to 1. Xs and Ys denote the coordinates of the interpolated AIS data. Xv and Yv denote the coordinates of the detected ship in the imagery. σVID represents the total error value related to the imagery reliability.

The threshold (a) can be defined according to Equation 9 below.

$$Threshold ( a ) = \frac{{C}_{AIS}}{{C}_{AIS} + {C}_{VID}} \qquad [ Equation 9 ]$$

Accordingly, the threshold (a) value may be determined by considering both the reliability of the AIS data and the reliability of the imagery, and can serve as a criterion for deciding whether the difference between the ship's position in the imagery and the position of the corrected AIS data results from the same ship's positional error or from two different ships.

If the error (d) exceeds the threshold (a), the position (coordinates) of the corrected AIS data may be applied to the ship information in the imagery (S640), since the corrected AIS data are more reliable than the ship information derived from the imagery.

Furthermore, when the error (d) exceeds the threshold (a), even though there exists a difference (d) between the coordinates of the ship in the corrected AIS data and the coordinates of the ship in the imagery, such a discrepancy may be regarded as a distortion caused by geometric or other physical factors. Accordingly, the information used for geometric correction can still be considered valid.

Meanwhile, when the error (d) is less than the threshold (a), the risk associated with errors in the corrected AIS data can be deemed greater than that associated with errors in the imagery, and therefore the ship data derived from the imagery can be interpreted as more reliable.

Therefore, when the error (d) is equal to or less than the threshold (a), the position (coordinate) values of the ship in the imagery may be directly applied (S650).

In other words, if the error (d) is equal to or less than the threshold (a), performing a geometric correction based on the AIS data may lead to inaccuracy in the output imagery, and thus, in such cases, the corresponding target may be excluded from establishing a Sea Control Point (SCP).

Additionally, when the error (d) is equal to or less than the threshold (a), since the data of the ship in the imagery are considered more reliable, incorrect matching between the image ship and AIS data can be prevented.

Accordingly, through the reliability evaluation formula for the AIS data and the ship data in the imagery, when the positions of the corrected AIS data and the target ship in the imagery differ, the reliability of specific data can be determined, thereby minimizing errors in the resulting output.

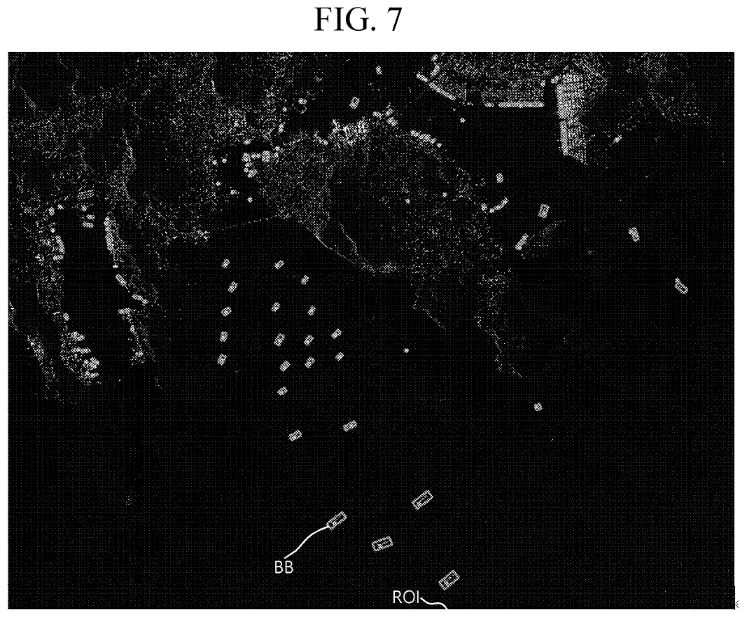

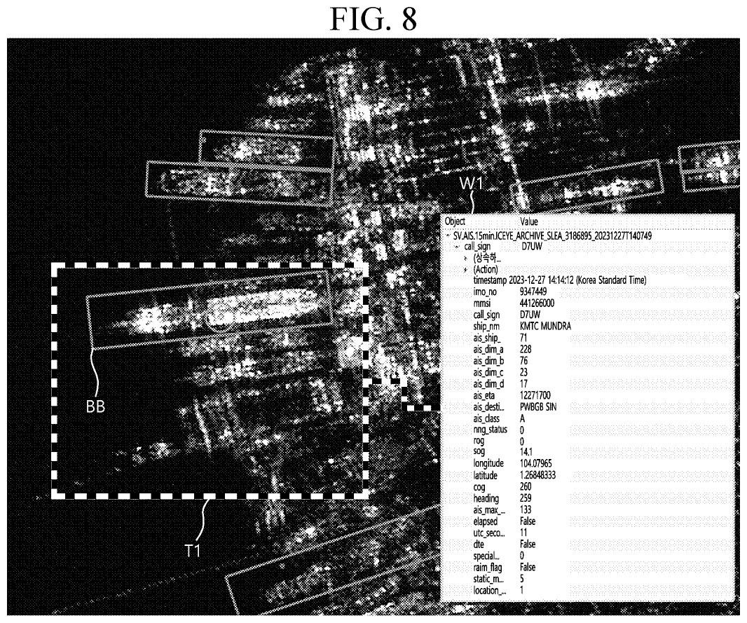

FIG. 7 is a view showing a screen for searching for and setting a target ship in a region of interest (ROI) within satellite imagery, according to an embodiment of the present invention. And FIG. 8 is a view showing a screen in which a target ship in satellite imagery and AIS data matched to the target ship are fused, according to an embodiment of the present invention.

In detail, FIG. 7 illustrates imagery of a user-selected Region of Interest (ROI) corresponding to a specific port, captured by a synthetic aperture radar. Referring to FIG. 7, detected ships in the imagery are defined by bounding boxes (BB), and bold points (center point) are provided to activate information for each ship. For example, in step S40 described above, one of the ships shown in FIG. 7 may be designated as a target.

Moreover, when a user selects one of these points, information about the corresponding ship, such as location coordinates, derivable from the satellite imagery may be displayed.

Referring to FIG. 8, when one of the detected ships (BB) in FIG. 7 is designated as a target (T1), a fused table (W1) combining or aligning corrected AIS data with the designated target (T1) can be displayed. For instance, information of the target ship (T1) may include time (including timestamp), IMO number, ship identifier, position (latitude, longitude), altitude, and so forth.

Therefore, when exploring maritime areas where traditional Ground Control Points (GCP) cannot be established, users can set ships fused with AIS data as Sea Control Points (that is, targets), thereby performing geometric corrections through satellite imagery translation, rotation, scaling, and coordinate transformations based on relational expressions.

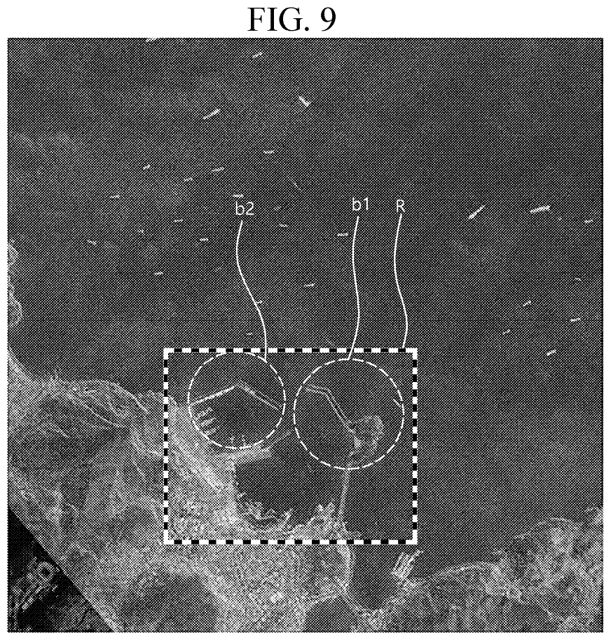

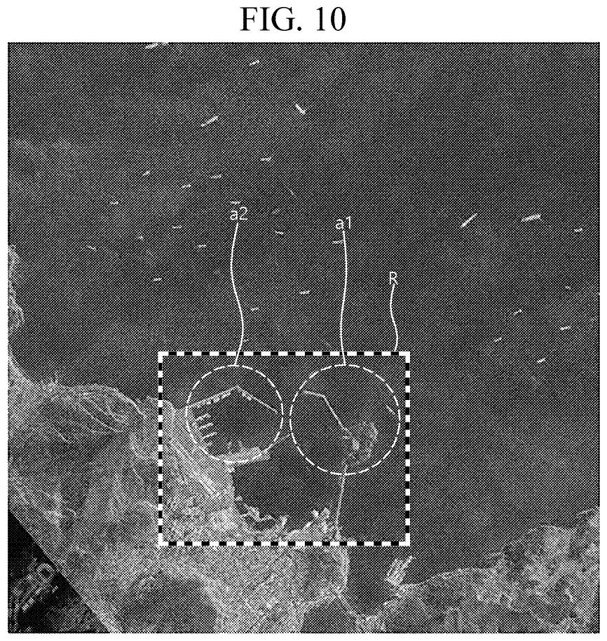

FIG. 9 is a view showing an image before geometric correction according to an embodiment of the present invention. And FIG. 10 is a view showing an image output after geometric correction according to an embodiment of the present invention.

Referring to FIG. 9, a distorted remote sensing image can be confirmed before performing geometric correction using a target ship as a Sea Control Point (SCP) according to the embodiment of the present invention described above. Specifically, Referring to FIG. 9, in the user interest region (R), the breakwater lines (b1, b2) forming the port appear distorted and overlapping due to mentioned distortion effects.

Referring to FIG. 10, after defining the target ship as a SCP and performing geometric correction, the breakwater lines (a1, a2) in the same ROI (R) are corrected to match the actual shape, removing distortions. Therefore, the output image of FIG. 10 can provide more precise and accurate remote sensing imagery.

The meaning of ‘fusion’ used in the above-described embodiment of the present invention, such as ‘fusion’ of AIS data matching the target ship, can also be understood to mean adjustment, alignment, combination, or integration.

According to the present invention, although it is relatively difficult to accurately and precisely identify information for each ship using satellite imagery alone, combining (or fusing) AIS information enables the provision of accurate and precise ship information within the satellite imagery.

According to the present invention, by utilizing AIS information, ships can be identified more accurately in satellite and aerial imagery, and errors caused by differences between the image capture time and the AIS data reception time can be corrected effectively with high reliability.

According to the present invention, because AIS information can be fused with ships detected in satellite and aerial imagery, problems inherent in conventional image-only identification and AIS-only identification can be complementarily mitigated, thereby providing more precise and accurate output results.

According to the present invention, since AIS information such as unique identifiers (e.g., IMO number), speed, and heading can be associated with ships in the imagery, precise tracking of actual ships in the imagery becomes possible and false positives can be reduced.

According to the present invention, for satellite and aerial imagery captured at a given time, interpolating AIS information to the image capture time offsets ship-position errors and enables more precise matching between ships and AIS data when many ships are detected within a narrow Region Of Interest.

According to the present invention, by computing the Euclidean distance between AIS data and ships in the imagery to analyze error and comparing the error to a threshold set based on reliability evaluation, more precise results can be output.

According to the present invention, AIS information can be accurately matched to the image capture time of remote sensing imagery.

According to the present invention, error factors in remote sensing imagery and error factors in AIS information can be complementarily mitigated.

According to the present invention, improving reliability by enabling more accurate data to be reflected in output results than before.

What is claimed is:

1. A ship identification system for satellite or aerial imagery, comprising:
a receiver configured to receive satellite or aerial imagery and AIS (Automatic Identification System) data;
a processor configured to preprocess the received AIS data and imagery, to define corrected AIS data by calculating information at the image capture time (ts) based on the received AIS data, and to match the corrected AIS data with ships detected in the imagery to fuse or combine multiple pieces of information; and
a display configured to output information of the ships subjected to fusion in the processor as imagery,
wherein the processor uses a linear interpolation or a velocity-and-direction-of-movement-based interpolation to correct the received AIS data to the image capture time (ts).

2. The ship identification system of claim 1, wherein the processor performs preprocessing of the received AIS data and imagery to remove noise and outliers prior to calculating the corrected AIS data.

3. The ship identification system of claim 1, wherein the processor extracts and filters erroneous AIS data caused by GPS anomalies or duplicated unique ship identifiers by separating the overlapping ship information based on position, course, and speed.

4. The ship identification system of claim 1, wherein the processor identifies ships within a Region Of Interest (ROI) in the imagery for which no corresponding AIS data is received, and designates such ships as unregistered or black ships for output based on imagery analysis.

5. The ship identification system of claim 1, wherein linear interpolation calculates AIS data at the image capture time based on AIS data received immediately before and after the image capture time by assuming uniform linear movement of ships.

6. The ship identification system of claim 1, wherein velocity-and-direction-of-movement-based interpolation calculates AIS data at the image capture time based on AIS data received immediately prior to the image capture time, considering ship velocity and azimuth angle.

7. The ship identification system of claim 1, wherein the processor includes:
a data processing unit configured to preprocess and correct the received AIS data to remove noise and outliers before calculating the corrected AIS data; and
an image processing unit configured to preprocess the received imagery and to detect and designate a target ship within a user-selected Region Of Interest (ROI),
wherein the image processing unit performs rotation, scaling, and other geometric transformations on the imagery based on the corrected AIS data at the image capture time.

8. The ship identification system of claim 7, wherein the processor further includes:
a combination unit matches the corrected AIS data to each target ship in the imagery and fuses the corresponding information for output.

9. The ship identification system of claim 8, wherein the combination unit computes a Euclidean distance error between a ship position in the imagery and the corrected AIS data, and evaluates reliability of each data source to apply the higher reliability data for fusion.

10. The ship identification system of claim 7, wherein the image processing unit defines a bounding box around each detected ship in the Region Of Interest (ROI) corresponding to the ships' length, width, and heading angle.

11. The ship identification system of claim 10, wherein a principal axis direction of the bounding box corresponds to the heading angle of the detected ship from the ship's center.

12. The ship identification system of claim 1, wherein the processor is configured to compares a distance, length, width and heading angle between the corrected AIS data and the detected ship in the image in that order, and scores the detected ship in the imagery by assigning a weight proportional to the order, thereby matching the corrected AIS data with the ship.

13. The ship identification system of claim 12, wherein, after the matching is complete, the processor performs a secondary matching of the remaining ships detected in the imagery with the remaining AIS data, and

14. The ship identification system of claim 13, wherein the processor excludes the remaining ships or the remaining AIS data from the secondary matching if a difference in heading angle between the remaining ships and the remaining AIS data is greater than 30 degrees, or if the remaining ships or the remaining AIS data are determined to be cluster of ships.

15. The ship identification system of claim 1, wherein the processor calculates an error between a position of a target ship in the imagery and a position of the corrected AIS data by Euclidean distance and evaluates a reliability of each to select data with higher reliability for fusion.

16. The ship identification system of claim 15, wherein the processor determines if the Euclidean distance error exceeds a threshold (a) derived from combined reliability assessments of AIS data and imagery before applying data fusion, and
wherein the threshold (a) is computed based on a ratio of reliability values of AIS data and the imagery to balance fusion accuracy.

17. The ship identification system of claim 1, wherein the processor defines one or more target ships as sea control points and performs geometric correction of the imagery by mapping pixel coordinates to actual geographic coordinates based on the corrected AIS data.

18. The ship identification system of claim 17, wherein the geometric correction includes first-order linear transformations such as translation, rotation, and scaling, and second-order nonlinear transformations to compensate for environmental factors.

19. A method for identifying ships in satellite or aerial imagery utilizing AIS data, comprising:
receiving satellite or aerial imagery and AIS data;
preprocessing the AIS data and imagery to remove noise;
correcting AIS data to correspond to an image capture time by interpolation;
detecting ships and defining targets in the imagery;
matching corrected AIS data with detected target ships; and
outputting fused ship information,
wherein the interpolation includes linear interpolation assuming constant velocity linear motion or velocity-and-direction-of-movement-based interpolation considering ship velocity and direction, and
wherein an error between positions of ships in the imagery and the corrected AIS data is calculated via Euclidean distance, and fusion is performed only when the error is below a reliability-based threshold (a).

20. The method of claim 19, further comprising performing geometric correction of the satellite or aerial imagery using ships detected as sea ground control points based on corrected AIS data.
